(19) United States
(12) Patent Application Publication
(10) Pub. No.: US 2026/0009695 A1
(43) Pub. Date: Jan. 8, 2026

(54) OPTICAL FREQUENCY DOMAIN REFLECTOMETER MODULE, OPTICAL FREQUENCY DOMAIN REFLECTOMETER SYSTEM AND METHOD OF OPERATING AN OPTICAL FREQUENCY DOMAIN REFLECTOMETER SYSTEM

(71) Applicant: Rohde & Schwarz GmbH & Co. KG, Muenchen (DE)

(72) Inventor: Jan HORN, Muenchen (DE)

(21) Appl. No.: 18/762,166

(22) Filed: Jul. 2, 2024

(51) Int. Cl. G01M 11/00; H04B 10/071

(52) U.S. Cl. CPC G01M 11/3172; H04B 10/071

(57) ABSTRACT

The present disclosure relates to an optical frequency domain reflectometer module, which includes an optical light source configured to generate a frequency modulated light signal. A splitter is connected with the optical light source, which splits a light signal received into a first split signal and a second split signal. A circulator is connected with the splitter so as to receive the first split signal. An optical interface receives the first split signal from the circulator, wherein the optical interface also forwards an optical return signal to the circulator. An optical coupler receives the second spit signal from the splitter and the optical return signal from the circulator. The optical coupler processes the second spit signal and the optical return signal so as to provide an optical beat signal.

### FIELD OF THE DISCLOSURE

Embodiments of the present disclosure relate to an optical frequency domain reflectometer module. Embodiments of the present disclosure also relate to an optical frequency domain reflectometer system as well as a method of operating an optical frequency domain reflectometer system.

### BACKGROUND

At present, optoelectronic devices become more popular in different technical fields, for instance telecommunication infrastructure, light detection and ranging, LIDAR systems for automotive applications, LIDAR systems for industrial applications, optical coherence tomography systems, Fiber Bragg Grating (FBG) based temperature monitoring systems, etc. The development of these different systems will create a need for test and/or measurement instruments to be used during development, integration and production of the respective optoelectronic devices.

An optical frequency domain reflectometer (OFDR) is an important device since it is used to evaluate the reflection behavior of a device under test. In the state of the art, reflectometers are known that are separately formed devices having their own software, e.g. their own operating system, such that persons interacting with those reflectometers have to be experts for the respective devices. In addition, another device is necessary for enabling a user to perform the respective test such that the costs are increased and further space is required.

Accordingly, there is a need for a customer-friendly possibility to evaluate a reflection behavior of an optoelectronic device under test.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure are directed to an optical frequency domain reflectometer (OFDR) module. In an embodiment, the OFDR module comprises an optical light source configured to generate an initial light signal that is a frequency modulated, FM, light signal. The OFDR module also comprises a splitter connected with the optical light source, wherein the splitter is configured to split a light signal received into a first split signal and a second split signal. The OFDR module also has a circulator connected with a splitter such that the first split signal provided by the splitter is received by the circulator. The OFDR module further comprises an optical interface connected with the circulator so as to receive the first split signal that is forwarded via the circulator, wherein the optical interface is also configured to forward an optical return signal from an optoelectronic device under test to the circulator. The OFDR module further comprises an optical coupler connected with a splitter and the circulator so as to receive the second split signal from the splitter and the optical return signal from the circulator. The optical coupler, for instance a 3 dB coupler, is configured to process the second split signal and the optical return signal so as to provide an optical beat signal. In an embodiment, the optical coupler combines the second split signal and the optical return signal so as to provide the optical beat signal. The optical beat signal has a beat frequency that is the absolute value of the difference of the frequencies of the second split signal and the optical return signal.

Embodiments of the present disclosure also provide an optical frequency domain reflectometer (OFDR) system that comprises a test and/or measurement instrument and the OFDR module described above, wherein the test and/or measurement instrument is connected with the OFDR module.

The main idea is to provide an add-on box for the test and/or measurement instrument, which comprises the functionality of an optical frequency domain reflectometer, OFDR. In an embodiment, the OFDR module is enabled to be connected to the test and/or measurement instrument while providing the optical beat signal or at least a representative signal for the optical beat signal. Thus, the OFDR module may process the optical beat signal generated prior to being forwarded to the test and/or measurement instrument.

In comparison to standalone reflectometers, the OFDR module connectable with the test and/or measurement instrument provides a better and more efficient usability for the user, as the user is enabled to use a well-known test and/or measurement instruments together with the OFDR module. Hence, the customer is not required to be expert for the standalone reflectometer as well, e.g. the software of the OFDR.

In addition, the OFDR module together with the test and/or measurement instrument provides a cost-efficient solution, as parts of the test and/or measurement instrument can be re-used to ensure the OFDR functionality.

For instance, signal acquisition and/or analyzing functionalities can be provided by the test and/or measurement instrument connected with the OFDR module rather than by the OFDR module itself, thereby enabling the OFDR module to be manufactured at lower costs compared to a standalone OFDR. In an embodiment, the respective functionality may be partly established by a software running on the test and/or measurement instrument such that the OFDR module itself does not require any software. In other words, the OFDR module may relate solely to hardware means. Hence, the OFDR module in one or more embodiments may be a software-free device that is connected to the test and/or measurement instrument. Put differently, the OFDR module adds hardware to the test and/or measurement instrument in order to increase the functionality of the test and/or measurement instrument.

In an embodiment, the optical light source of the OFDR module generates the frequency modulated light signals, for instance linear frequency chirps, also called sweeps.

In an embodiment, the optical interface is used for connecting the OFDR module with an optoelectronic device under test, namely an optoelectronic device to be tested. Therefore, the reflection behavior of the optoelectronic device under test connected with the optical interface can be evaluated by the OFDR module together with the test and/or measurement instrument connected with the OFDR module, e.g. based on the frequency modulated light signals generated by the optical light source of the OFDR module. The optoelectronic device under test receives and processes an optical signal derived from the optical light source, namely the initial light signal, thereby generating the optical return signal which is indicative of the reflection behavior of the optoelectronic device under test. Moreover, the OFDR module transfers a reflection behavior of the device under test into the spectral domain for further analysis, e.g. by the test and/or measurement instrument.

Generally, the OFDR system may be used for testing and analyzing optical systems or their components, e.g. the optoelectronic devices under test. For instance, photonic integrated circuits (PICs) may be tested by the OFDR system. Hence, the optoelectronic device under test may be a PIC.

According to an embodiment, the OFDR module comprises a photo diode connected with the optical coupler so as to receive the optical beat signal. The photo diode is configured to receive and process the optical beat signal, thereby generating an electrical signal representative of the optical beat signal. The OFDR module comprises an amplifier connected with the photo diode, which is configured to amplify the electrical signal received from the photo diode, thereby creating an amplified electrical signal that is representative of the optical beat signal. The OFDR module comprises an electrical output interface connected with the amplifier. Therefore, the OFDR module itself is enabled to process the optical beat signal internally so as to provide the (amplified) electrical signal representative of the optical beat signal, which is forwarded to the test and/or measurement instrument for further processing, e.g. analysis. Since an electrical signal is outputted by the OFDR module, a standard probe or a standard electrical cable can be used for forwarding the electrical signal from the OFDR module to the test and/or measurement instrument. The electrical signal generally relates to an analog signal that can be processed by the test and/or measurement instrument.

In an embodiment, the amplifier used for amplifying the electrical signal generated may relate to a transimpedance amplifier (TIA). The electrical output interface may be associated with an electrical signal connector that is configured to provide the amplified electrical signal.

According to another embodiment, the OFDR module comprises an optical output interface that is connected with the optical coupler so as to output the optical beat signal. Accordingly, the OFDR module may directly output the optical beat signal provided by the optical coupler via the optical output interface. Hence, the OFDR module itself does not process the optical beat signal further in order to generate an electrical signal for being forwarded to the test and/or measurement instrument. In an embodiment, the OFDR system may comprise an optical probe that is interconnected between the optical output interface and the test and/or measurement instrument. The optical probe converts the optical signal received via the optical output interface, namely the optical beat signal, into an electrical signal to be processed by the test and/or measurement instrument. The optical probe may relate to a single diode optical probe. Hence, the OFDR module itself only comprises the optical coupler used to combine the optical return signal and a local oscillator signal, namely the second split signal received from the splitter. As described above, the optical coupler processes/combines the signals received in order to obtain the optical beat signal.

In an embodiment, the optical probe interconnected between the OFDR module and the test and/or measurement instrument may additionally comprise a photo diode and the amplifier, for example the transimpedance amplifier, TIA. Since the OFDR module having the optical output interface does not comprise the photo diode and the amplifier, the OFDR module with the optical output interface can be manufactured more cost-efficiently compared to the OFDR module having an electrical output interface. This is particularly beneficial in case a customer/user needs the optical probe for other measurements anyway.

Another aspect provides that the OFDR module comprises, for example, a pre-splitter located prior to the splitter such that the pre-splitter is located between the optical light source and the splitter. In an embodiment, the pre-splitter is configured to split the initial light signal (directly) received from the optical light source into a pre-split light signal and the light signal that is forwarded to the splitter. In an embodiment, a Mach-Zehnder-Interferometer is connected with the pre-splitter so as to receive the pre-split light signal from the pre-splitter. The Mach-Zehnder-Interferometer is configured to convert an instantaneous frequency tuning rate of the pre-split light signal into a further optical signal, e.g. a reference signal. The optical frequency domain reflectometer module comprises an optical output interface that is connected with the Mach-Zehnder-Interferometer so as to output the further optical signal. Hence, the OFDR module may comprise two optical output interfaces, namely a first optical output interface for outputting the optical beat signal provided by the optical coupler, and a second optical output interface to provide the further optical signal obtained from the Mach-Zehnder-Interferometer.

However, the OFDR module in other embodiments may also comprise the electrical output interface for outputting the electrical signal indicative of the optical beat signal as well as one optical output interface for outputting the further optical signal, namely the reference signal. The further optical signal provided by the Mach-Zehnder-Interferometer while processing the pre-split light signal can be used for a closed control loop of the optical light source. In an embodiment, the further optical signal outputted via the optical output interface, namely the second optical output interface, may be forwarded to the test and/or measurement instrument, for example via an optical probe. The test and/or measurement instrument is enabled to process the further optical signal, namely the reference signal, in order to gather information used for controlling the optical light source and/or re-sampling the optical beat signal received from the OFDR module.

In an embodiment, the optical frequency domain reflectometer module may comprise a pre-splitter located prior to the splitter such that the pre-splitter is located between the optical light source and the splitter, wherein the pre-splitter is configured to split the initial light signal into the light signal to be forwarded to the splitter and a pre-split light signal, wherein a Mach-Zehnder-Interferometer is connected with the pre-splitter so as to receive the pre-split light signal from the pre-splitter, wherein the Mach-Zehnder-Interferometer is configured to process the pre-split light signal received from the pre-splitter, thereby generating a reference signal, and wherein the Mach-Zehnder-Interferometer is connected to a photo diode that receives the reference signal. The photo diode converts the optical reference signal received from the Mach-Zehnder-Interferometer into an electrical signal. Hence, an electrical output interface may be connected with the photo diode, to which the test and/or measurement instrument can be connected. The photo diode is part of the OFDR module. Furthermore, an amplifier, for example a transimpedance amplifier (TIA) is interconnected between the photo diode and the electrical output interface of the OFDR module. Consequently, the amplifier is also part of the OFDR module.

Generally, optical tests performed on the devices under test, namely the optoelectronic devices, are carried out where elements in the optical path do not move. Therefore, Doppler-shifts do not occur such that they do not have to be compensated. This enables applying a k-clock resampling scheme as known from optical coherence tomography (OCT). The k-clock resampling scheme applied enables to omit an acousto-optical modulator (AOM), which is usually required. Hence, the overall costs of the OFDR module can be reduced, thereby reducing the costs of the OFDR system as well.

In an embodiment, a closed loop control may be achieved since the optical light source is driven with an open loop profile and yields only close to linear chirps which generally would not allow high quality measurements, namely accurate measurements. In an embodiment, a resampled optical signal obtained has a spectral content that corresponds to a signal acquired based on (close to) perfectly linear chirps of the optical light source. However, the reference signal received from the Mach-Zehnder-Interferometer can be used to calculate the resampling time instants for the optical beat signal, thereby increasing the quality/accuracy. Actually, the resampled optical beat signal obtained has a spectral content that corresponds to a perfectly linear chirps.

Generally, two different approaches for k-clock resampling may be applied, namely direct binarization of the reference signal while sampling at edges or computation of re-sampling instants based on the Hilber-transformation of the reference signal.

Another aspect provides that the optical interface, for example, is a bidirectional optical interface to be connected with an optoelectronic device under test. As indicated above, the optical interface connected with the circulator is used for forwarding the first split signal to the optical interface and the device under test connected thereto. In addition, the optical interface also receives the optical return signal from the optoelectronic device under test, which is forwarded to the circulator for being routed to the optical coupler that generates the optical beat signal inter alia based on the optical return signal provided by the optoelectronic device under test. Therefore, optical signals, namely the first split signal and the optical return signal, are processed by the optical interface in both directions.

In an embodiment, the optical light source may be a laser source, for example a swept laser source. Hence, coherent light is generated.

In an embodiment, the optical frequency domain reflector module may comprise a digital controller configured to control the optical light source. As indicated above, the optical light source may be a laser source that can be controlled easily by the digital controller.

For instance, the OFDR module comprises a digital-to-analog converter, DAC, and a driver. The DAC is configured to receive a (digital) control signal from the digital controller and to convert the (digital) control signal into an analog signal. The driver is configured to control the optical light source based on the analog signal. Therefore, cost-efficient components can be used for implementing the controlling of the optical light source, as an analog driver is provided that receives the analog control signals for controlling the optical light source accordingly. The digital controller together with the DAC mainly has the task to provide an open loop drive profile to the optical light source.

If the optical light source is controlled by a closed loop, usually special customized pre-distortion signal profiles need to be replayed to allow an optical phase locked loop (OPLL) to lock properly and quickly. These pre-distortion profiles are to bring the optical light source already in open loop mode close to emitting linear chirps.

In an embodiment, the OFDR module may comprise a drive signal input configured to receive a drive signal. The drive signal input may be connected with the test and/or measurement instrument that provides the drive signal to be processed by the OFDR module for controlling the optical light source. As discussed above, the test and/or measurement instrument may receive the further optical signal, namely the reference signal, from the OFDR module based on which the drive signal may be generated in order to control the optical light source appropriately. Thus, a closed loop control can be established.

Generally, the OFDR module may be an OFDR front-end connectable with the test and/or measurement instrument. Hence, the OFDR module may be connected with interfaces of the test and/or measurement instrument, which are provided at the front-end of the test and/or measurement instrument. Therefore, the OFDR module itself is an extension module for the front-end of the test and/or measurement instrument in order to increase the functionality of the test and/or measurement instrument. Hence, the OFDR module connected to the front-end of the test and/or measurement instrument corresponds to an OFDR front-end.

An aspect provides that the test and/or measurement instrument comprises, for example, a signal acquisition and/or analysis circuit connected with an output interface of the OFDR module. The output interface may be an optical output interface or an electrical output interface. Depending on the respective kind of output interface of the OFDR module, a different probe may be interconnected between the test and/or measurement instrument and the OFDR module. Irrespective thereof, the OFDR module does not comprise any signal acquisition and/or analysis circuit since the respective functionalities are outsourced to the test and/or measurement instrument, thereby reducing the costs of the OFDR module significantly.

In an embodiment, the OFDR system may comprise the optoelectronic device under test that is connected with the optical interface of the OFDR module. The optoelectronic device under test may be tested by the combination established by the OFDR module and the test and/or measurement instrument accordingly.

Embodiments of the present disclosure also provide a method of operating an optical frequency domain reflectometer system. In an embodiment, the method comprises the steps of:
Generating an initial light signal by an optical light source of an OFDR module,
Splitting the initial light single into a pre-split light signal and a light signal by a pre-splitter of the OFDR module, which is connected with the optical light source,
Processing the pre-split light signal by a Mach-Zehnder-Interferometer of the OFDR module, thereby generating a reference signal,
Generating an optical beat signal based on the light signal by an optical coupler of the OFDR module,
Determining resample time-instants based on the reference signal by the test and/or measurement instrument, for example a signal acquisition and/or analysis circuit of the test and/or measurement instrument,
Resampling the optical beat signal based on the resampled time-instants determined by the test and/or measurement instrument, thereby obtaining a resampled optical beat signal, and
Computing a magnitude spectrum based on the resampled optical beat signal by the test and/or measurement instrument, for example the signal acquisition and/or analysis circuit of the test and/or measurement instrument.

Accordingly, a k-clock resampling may be performed by the OFDR system, for example the OFDR module connected with the test and/or measurement instrument. The respective calculations and/or computations are performed by the test and/or measurement instrument, for example the signal acquisition and/or analysis circuit of the test and/or measurement instrument.

An aspect provides that a reflection profile of the device under test, for example, is retrieved from the magnitude spectrum computed. Hence, the reflection behavior of the optoelectronic device under test can be determined accordingly.

In an embodiment, the resampled time-instants may be determined by performing a Hilbert-transformation of the reference signal.

In an embodiment, the Mach-Zehnder-Interferometer of the OFDR module may process the pre-split light signal in order to generate the reference signal based on which the resampled time-instants are determined, e.g. by performing the Hilbert-transformation.

In an embodiment, the light signal forwarded to the splitter of the OFDR module may be split into a first split signal and a second split signal. The first split signal is forwarded to an optoelectronic device under test that returns an optical return signal. The optical beat signal is generated based on the second split signal and the optical return signal obtained from the optoelectronic device under test. The optoelectronic device under test provides the optical return signal based on the first split signal forwarded to the optoelectronic device under test. Since the second split signal and the first split signal both are obtained from the light signal, the optical beat signal is generated based on the light signal derived from the optical light source.

Generally, the hardware of the test and/or measurement instrument, namely the signal acquisition and/or analysis circuit, may be used for performing the respective computation. Hence, the resampling may also be done by the signal acquisition and/or analysis circuit of the test and/or measurement instrument.

In an embodiment, the signal acquisition and/or analysis circuit may be established on a field-programmable gate array, FPGA.

As described above, open loop drive profiles may be provided to the optical light source. The test and/or measurement instrument may comprise an arbitrary wave generator (AWG), which can be used to provide the pre-distortion profiles for the optical light source.

Hence, the digital controller of the OFDR module can be omitted since the respective profiles are directly provided by the test and/or measurement instrument connected with the OFDR module.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an optical frequency domain reflectometer system according to an embodiment of the present disclosure,

FIG. 2 schematically shows an overview of a light signal provided by the optical light source of the optical frequency domain reflectometer module used in the optical frequency domain reflectometer system according to FIG. 1,

FIG. 3 schematically shows an overview for illustrating a reflection profile retrieved from the spectrum of the optical beat signal,

FIG. 4 schematically shows an optical frequency domain reflectometer system according to another embodiment of the present disclosure,

FIG. 5 schematically shows an optical frequency domain reflectometer system according to another embodiment of the present disclosure, and

FIG. 6 schematically shows an overview illustrating an approach of k-clock resampling to be used in a method of operating an optical frequency domain reflectometer system according to an embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

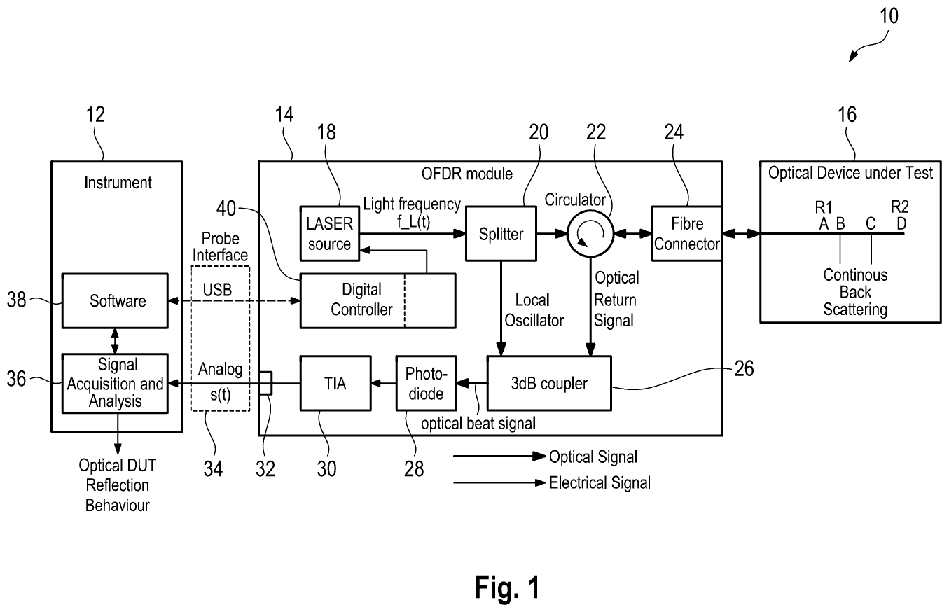

FIG. 1 depicts an optical frequency domain reflectometer (OFDR) system 10 in accordance with an embodiment of the present disclosure. As shown in FIG. 1, the system 10 comprises a test and/or measurement instrument 12, for instance an oscilloscope, and an optical frequency domain reflectometer (OFDR) module 14 that is connected with the test and/or measurement instrument 12, e.g., with a front-end of the test and/or measurement instrument 12. Accordingly, the OFDR module 14 is an add-on unit or apparatus with respect to the test and/or measurement instrument 12.

The OFDR system 10 further comprises an optoelectronic device under test 16 that is connected with the OFDR module 14 as will be described later in more detail.

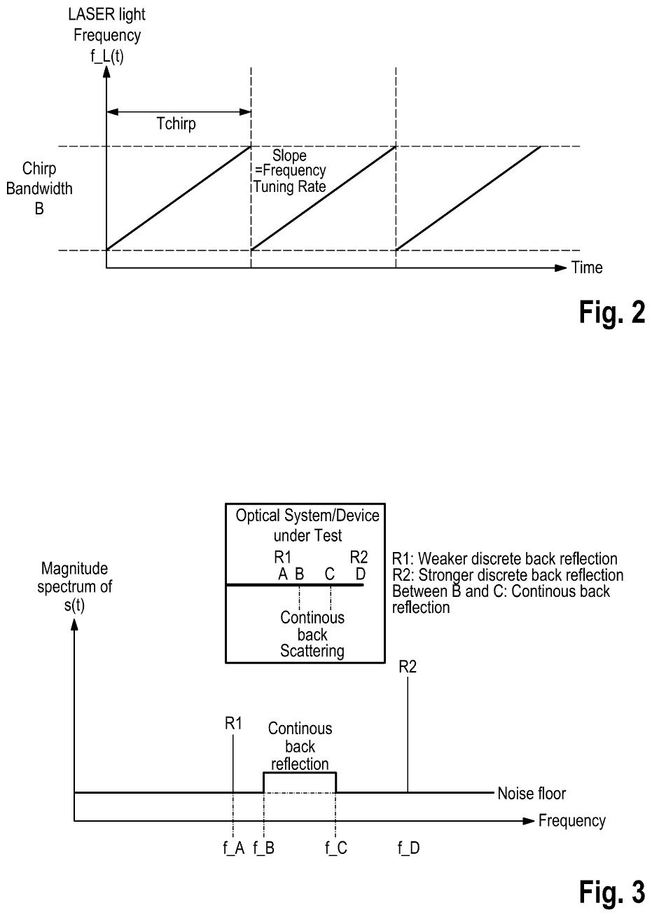

In the embodiment of FIG. 1, the OFDR module 14 comprises an optical light source 18 that is established, for example, by a laser. The optical light source 18 is configured to generate an initial light signal that is a frequency modulated (FM) light signal. The light signal may relate to linear frequency chirps, also called sweeps, as shown in FIG. 2. Alternatively to the up-chirps shown in FIG. 2, the optical light signal may also relate to down-chirps or a combination of up-chirps and down-chirps, also called up-down-chirps. The combination of up-chirps and down-chirps is advantageous compared to up-chirps or down-chirps as no large steps are provided, but smooth transitions, resulting in a simplified controlling. Moreover, the combination of up-chirps and down-chirps allow Doppler effect compensations if necessary.

In general, the light signal is outputted by the optical light source 18 for testing the device under test 16, for example its reflection behavior.

As shown in FIG. 1, the optical light source 18 is connected with a splitter 20 of the OFDR module 14. The splitter 20 is configured to split the light signal received into a first split signal that is forwarded to a subsequent circulator 22 and a second split signal, also called namely local oscillator signal as shown in FIG. 1.

A circulator 22 is connected with the splitter 20 such that the circulator 22 receives the first split signal. The circulator 22 is also connected to an optical interface 24 that may be established by a fiber connector or a sleeve. Thus, the optical interface 24 receives the first split signal from the splitter 20 forwarded via the circulator 22.

In an embodiment, the optical interface 24 is connected with the optoelectronic device under test 16 such that the first split signal is forwarded to the optoelectronic device under test 16. The optoelectronic device under test 16 outputs an optical return signal that is received by the optical interface 24 as well. The optical interface 24 forwards the optical return signal to the circulator 22. Hence, the optical interface 24 is a bidirectional interface, as optical signals are processed by the optical interface 24 in both directions, namely towards the optoelectronic device under test 16 and from the optoelectronic device under test 16.

In an embodiment, the circulator 22 as well as the splitter 20 are further connected to an optical coupler 26, for example, a 3 dB coupler. Accordingly, the optical coupler 26 receives the second split signal from the splitter 20, namely the local oscillator signal, and the optical return signal form the circulator 22 that has received the optical return signal from the optoelectronic device under test 16 via the optical interface 24.

In an embodiment, the optical coupler 26 combines the second split signal, e.g. the local oscillator signal, and the optical return signal so as to provide an optical beat signal. Based thereon the reflection behavior of the optoelectronic device under test 16 can be evaluated.

In the shown embodiment, the OFDR module 14 further comprises a photo diode 28 that is connected with the optical coupler 26. The photo diode 28 processes the optical beat signal outputted by the optical coupler 26, thereby generating an electrical signal that is forwarded to an amplifier 30, for instance a transimpedance amplifier (TIA). The amplifier 30 amplifies the electrical signal such that an amplified electrical signal is obtained that is forwarded to an electrical output interface 32 of the OFDR module 14.

In an embodiment, the OFDR module 14 is connected with the test and/or measurement instrument 12 via the electrical output interface 32 wherein a probe interface 34 is provided by the test and/or measurement instrument 12, by the OFDR module 14 or between the test and/or measurement instrument 12 and the OFDR module 14.

The electrical signal outputted by the OFDR module 14 that is indicative of the optical beat signal is an analog signal s(t) which is internally processed by the test and/or measurement instrument 12, for example a signal acquisition and/or analysis circuit 36. A user may interact with the signal acquisition and/or analysis circuit 36 via a software 38, for instance a graphical user interface, so as to make settings of the test and/or measurement instrument 12 or to obtain analyzing results.

The test and/or measurement instrument 12 processes the electrical signal outputted by the OFDR module 14, which is indicative of the optical beat signal provided by the optical coupler 26, thereby obtaining a reflection behavior of the optoelectronic device under test 16, an example of which is shown in FIG. 3.

FIG. 3 explains the relation between the reflection behavior of the optoelectronic device under test 16 and the magnitude spectrum of the beat signal s(t) forwarded to the test and/or measurement instrument 12. A discrete reflex yields a peak in the signal spectrum as indicated in FIG. 3.

The frequency of the peak corresponds to the location of the reflex in the optoelectronic device under test 16, the magnitude of the peak relates to the magnitude of the reflex in the optoelectronic device under test 16. Continuous reflexes, e.g. from back scattering, are represented by increased spectral content, namely bins. The band in which this increased spectral content can be observed is directly connected to the spatial limits of the continuous reflection.

Discrete reflexes can happen at a transition from a fiber to a photonic integrated circuit (PIC) or at an optical element in a PIC, for instance a thermo-optical phase shifter or a grating coupler.

Continuous back reflections may happen in waveguides on a photonic integrated circuit at a higher extent than in discrete fibers.

For instance, the distance from the splitter 20 in the OFDR module 14 may be denoted by x. The frequency of a reflex at the location x can be described as follows:

$$f = \frac{2 x}{c} F T R$$

wherein c is the speed of light and FTR relates to the frequency tuning rate, namely the chirp rate, of the optical light source 18.

The resolution Δx of the OFDR system 10 can be described as follows:

$$Δ x = \frac{c}{2 B}$$

wherein B is the bandwidth of the light signal during acquisition of the signal s(t). Accordingly, a higher chirp bandwidth leads to a higher spatial resolution. A higher FTR limits the maximum range, e.g. maximum frequency limited by system bandwidth including s(t) acquisition bandwidth. As indicated above, a higher FTR is one option to increase the chirp bandwidth and therefore the resolution of the OFDR system. But this in turn is limited by the acquisition bandwidth of the test and/or measurement instrument. A higher FTR increases the frequency at which peaks for reflexes are located in the beat signal spectrum. Therefore, a higher FTR increases the required acquisition bandwidth of the test and/or measurement instrument.

The combination of the OFDR module 14 with the test and/or measurement instrument 12 is advantageous since the test and/or measurement instrument 12 has a high sampling rate and allow high signal bandwidths of s(t). This means that high resolution OFDR measurements are possible even for higher ranges (long light travel distances within the optoelectronic device under test 16 with shorter acquisition times.

In FIG. 1, it is further shown that the optical light source 18 is controlled via a digital controller 40 that interacts with the test and/or measurement instrument 12, for instance by a universal serial bus, USB, connection.

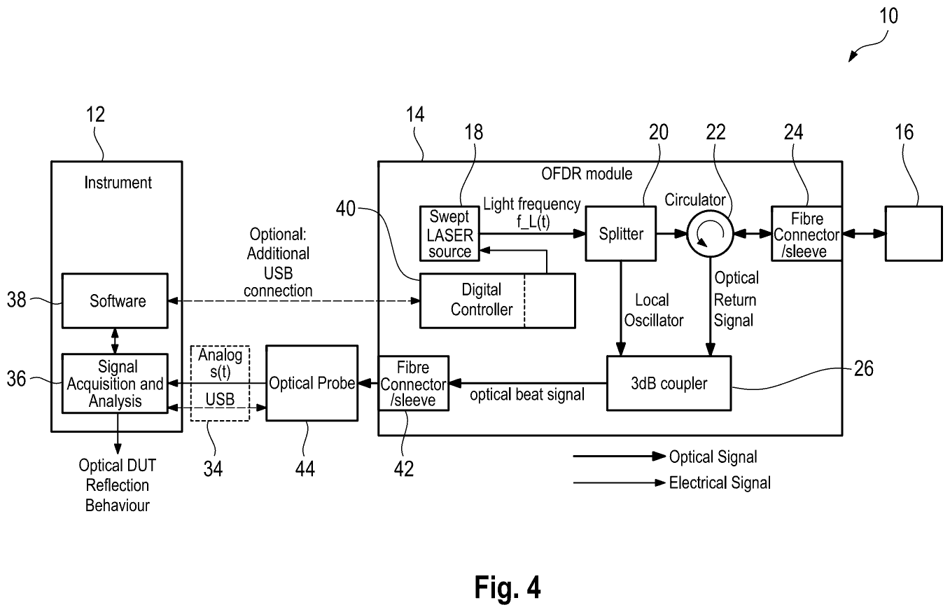

In FIG. 4, another embodiment of the OFDR system 10 is shown which differs from the embodiment shown in FIG. 1 in that the OFDR module 14 comprises an optical output interface 42 instead of the electrical output interface 32. Accordingly, the optical output interface 42 is (directly) connected with the optical coupler 26 such that the optical beat signal is outputted by the OFDR module 14.

The OFDR system 10 according to the embodiment of FIG. 4 further comprises an optical probe 44 that is interconnected between the test and/or measurement instrument 12 and the OFDR module 14. The optical probe 44 comprises an internal photo diode so as to convert the optical beat signal outputted by the OFDR module 14 via its optical output interface 42 into an electrical signal that is forwarded to the test and/or measurement instrument 12 for being processed accordingly. Optionally, the optical probe 44 comprises an amplifier for amplifying the electrical signal before it is forwarded to the test and/or measurement instrument 12.

Hence, the OFDR module 14 of the OFDR system 10 shown in FIG. 4 can be manufactured in a more cost-efficient manner, as the photo diode and the amplifier is not part of the OFDR module 14, but of the optical probe 44 that may be used by the user for other measurements anyway.

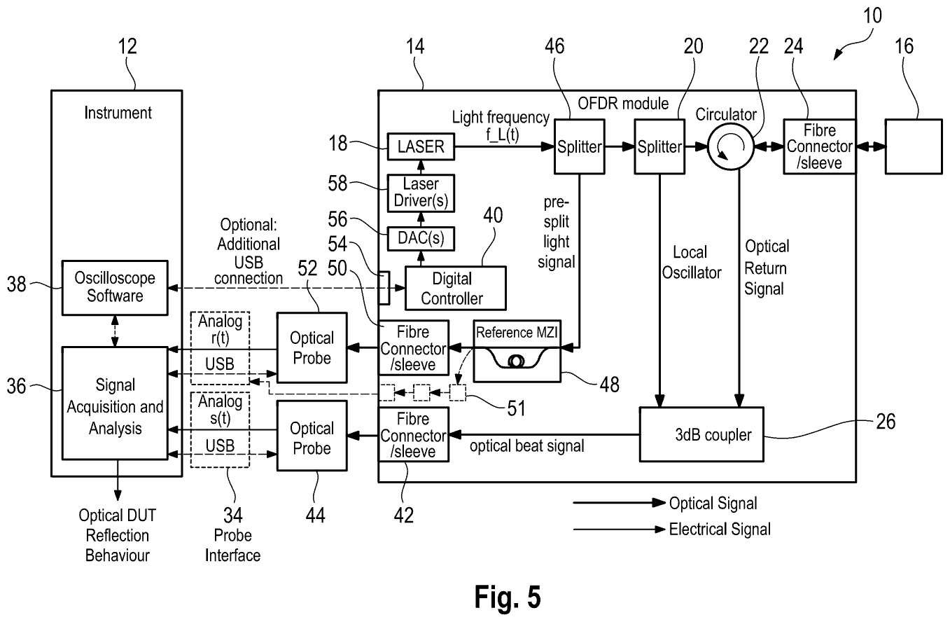

In FIG. 5, the OFDR system 10 of FIG. 4 is shown in more detail, wherein components used for k-clock sampling are illustrated in detail. The OFDR module 14 shown in FIG. 5—similar to the embodiment shown in FIG. 4—also comprises the optical output interface 42. Alternatively, the OFDR module 14 may however comprise an internal photo diode 28 as well as an internal amplifier 30 as well as the electrical output interface 32 as shown in the embodiment of FIG. 1.

The OFDR module 14 according to FIG. 5 differs from the one of FIG. 4 in that the components used for the for k-clock sampling are illustrated. In an embodiment, the OFDR module 14 comprises a pre-splitter 46 that is located between the optical light source 18 and the splitter 20 such that the initial light signal outputted by the optical light source 18 is split into the light signal to be forwarded to the splitter 20 and a pre-split light signal that is forwarded to a Mach-Zehnder-Interferometer 48 for providing a reference signal.

The Mach-Zehnder-Interferometer 48 converts an instantaneous frequency tuning rate (FTR) of the pre-split light signal into a further optical signal, namely a reference signal, that is forwarded to an optical output interface 50 via which the further optical signal can be outputted.

Generally, the Mach-Zehnder-Interferometer 48 is configured to process the pre-split light signal received from the pre-splitter 46, thereby generating the reference signal. The optical reference signal generated may be processed by an internal photo diode 51 (dashed lines) which converts the optical reference signal into an electrical signal. An optional amplifier (dashed lines), e.g. a transimpedance amplifier (TIA) may be connected with the photo diode in order to amplify the electrical signal obtained from the photo diode. Consequently, the OFDR module 14 has an electrical output interface (dashed lines) associated with the Mach-Zehnder-Interferometer 48. Thus, the reference signal converted into the electrical signal, namely the electrical reference signal, is forwarded to the test and/or measurement instrument 12 via the electrical output interface. Accordingly, the optical probe 52 can be omitted. In an embodiment, this setup corresponds to the one shown with respect to FIG. 1 in which it is illustrated that the optical beat signal is processed by the photo diode 28 and the subsequent amplifier 30 before being outputted via the electrical output interface 32 of the OFDR module 14. The same concept may also be applied to the Mach-Zehnder-Interferometer 48 shown in FIG. 5 so as to replace the optical output interface 50 by an electrical output interface.

As shown in FIG. 5, the test and/or measurement instrument 12 is connected with the optical output interface 50 so as to receive the further optical signal, wherein the further optical signal is converted into an electrical signal by an additional optical probe 52 interconnected between the test and/or measurement instrument 12 and the OFDR module 14.

The reference signal obtained from the OFDR module 14 is processed by the test and/or measurement instrument 12 so as to obtain information/data based on which a drive signal is generated for controlling the optical light source 18. The drive signal is forwarded to a drive signal input 54 of the OFDR module 14 that is connected with the digital controller 40 that processes the drive signal received accordingly.

The digital controller 40 is connected with at least one digital-to-analog converter, DAC, 56 that processes a (digital) control signal from the digital controller 40, which is based on the drive signal received via the drive signal input 54. The (analog) control signal provided by the DAC 56 is forwarded to a driver 58 of the OFDR module 14, which processes the control signal so as to control/drive the optical light source 18 accordingly.

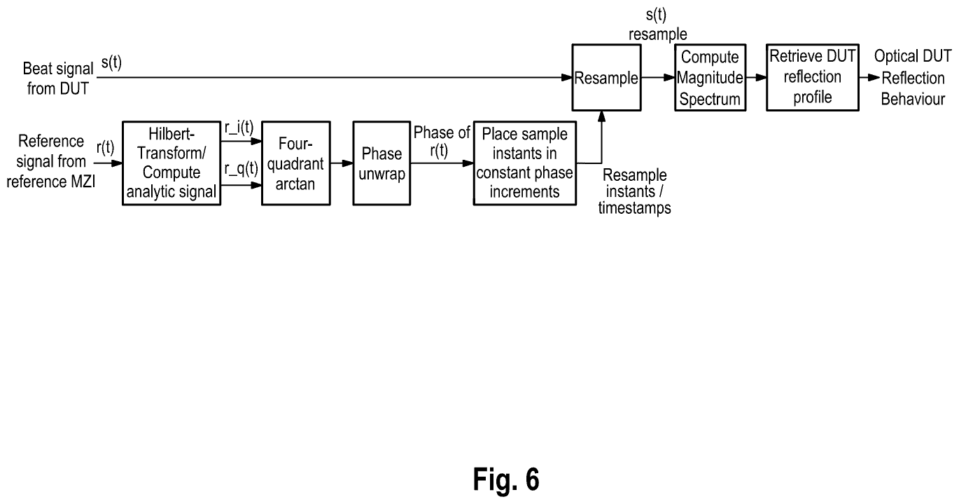

In FIG. 6, the respective method of operating the OFDR system 10 is shown in more detail, for example concerning the k-clock resampling. This relates, for example, to a closed loop controlling or a closed loop feedback.

As described with reference to embodiments described above, an optical beat signal is generated by the OFDR module 14, for example its optical coupler 26.

In addition and as shown in the detailed illustration of FIG. 5, a reference signal may also be generated by the OFDR module 14, namely based on the pre-split light signal obtained from the pre-splitter 46 connected to the optical light source 18. The pre-split light signal is processed by the Mach-Zehnder-Interferometer 48 so as to provide the optical reference signal that is converted into an electrical signal for being processed by the test and/or measurement instrument 12, for example its signal acquisition and/or analysis circuit 36.

The optical reference signal, namely its electrical representative, is processed by the test and/or measurement instrument 12 while performing a Hilbert-transformation in order to compute an analytic signal. The respective signals obtained, namely r_i(t) and r_q(t) for I- and Q-components of an IQ signal, are further processed, e.g. determining four-quadrant arctangent functions of the transforms of the IQ signal and performing a phase unwrap, thereby gathering phase of the reference signal. The phase of the reference signal is processed to place sample instants in constant phase increments, thereby obtaining resample time-instants/timestamps.

In an embodiment, the resample time-instants are determined based on the reference signal which are used by the test and/or measurement instrument 12 to resample the optical beat signal or a representative of the optical beat signal based on the resample time-instants determined.

Consequently, a resampled optical beat signal is obtained based on which further analysis can be done, namely computation of a magnitude spectrum.

Afterwards, the reflection profile of the optoelectronic device under test 16 can be obtained based on the magnitude spectrum as shown in FIG. 3, which is used for evaluating the reflection behavior of the optoelectronic device under test 16.

As already described above, the optical light source 18 can be controlled based on an optical phase locked loop (OPLL) but the k-clock resampling is performed so as to avoid cost-intensive components like an acousto-optical modulator (AOM). In an embodiment, the k-clock resampling ensures that nonlinearities of the frequency modulation of the optical light source 18 are corrected.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components of the system 10, such as the test and/or measurement instrument, etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible to a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based circuits, etc., that perform the specified functions or operations, or combinations of special purpose hardware and computer instructions.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. An optical frequency domain reflectometer module, wherein the optical frequency domain reflectometer module comprises:
an optical light source configured to generate an initial light signal that is a frequency modulated light signal,
a splitter connected with the optical light source, wherein the splitter is configured to split a light signal received into a first split signal and a second split signal,
a circulator connected with the splitter such that the first split signal provided by the splitter is received by the circulator,
an optical interface connected with the circulator so as to receive the first split signal that is forwarded via the circulator, wherein the optical interface is configured to forward an optical return signal to the circulator, and
an optical coupler connected with the splitter and the circulator so as to receive the second spit signal from the splitter and the optical return signal from the circulator, wherein the optical coupler is configured to process the second spit signal and the optical return signal so as to provide an optical beat signal.

2. The optical frequency domain reflectometer module according to claim 1, further comprising
a photo diode connected with the optical coupler so as to receive the optical beat signal, wherein the photo diode is configured to receive and process the optical beat signal, thereby generating an electrical signal;
an amplifier connected with the photo diode, which is configured to amplify the electrical signal received from the photo diode; and
an electrical output interface connected with the amplifier.

3. The optical frequency domain reflectometer module according to claim 1, further comprising an optical output interface that is connected with the optical coupler so as to output the optical beat signal.

4. The optical frequency domain reflectometer module according to claim 1, further comprising a pre-splitter located prior to the splitter such that the pre-splitter is located between the optical light source and the splitter, wherein the pre-splitter is configured to split the initial light signal into the light signal to be forwarded to the splitter and a pre-split light signal, wherein a Mach-Zehnder-Interferometer is connected with the pre-splitter so as to receive the pre-split light signal from the pre-splitter, wherein the Mach-Zehnder-Interferometer is configured to convert an instantaneous frequency tuning rate of the pre-split light signal into a further optical signal, and wherein the optical frequency domain reflectometer module further comprises an optical output interface that is connected with the Mach-Zehnder-Interferometer so as to output the further optical signal.

5. The optical frequency domain reflectometer module according to claim 1, further comprising a pre-splitter located prior to the splitter such that the pre-splitter is located between the optical light source and the splitter, wherein the pre-splitter is configured to split the initial light signal into the light signal to be forwarded to the splitter and a pre-split light signal, wherein a Mach-Zehnder-Interferometer is connected with the pre-splitter so as to receive the pre-split light signal from the pre-splitter, wherein the Mach-Zehnder-Interferometer is configured to process the pre-split light signal received from the pre-splitter, thereby generating a reference signal, and wherein the Mach-Zehnder-Interferometer is connected to a photo diode that receives the reference signal.

6. The optical frequency domain reflectometer module according to claim 1, wherein the optical interface is a bidirectional optical interface to be connected with a device under test and/or wherein the optical light source is a laser source.

7. The optical frequency domain reflectometer module according to claim 1, further comprising a digital controller configured to control the optical light source.

8. The optical frequency domain reflectometer module according to claim 7, further comprising a digital-to-analog converter and a driver, wherein the digital-to-analog converter is configured to receive a control signal from the digital controller and to convert the control signal into an analog signal, wherein the driver is configured to control the optical light source based on the analog signal.

9. The optical frequency domain reflectometer module according to claim 1, further comprising a drive signal input configured to receive a drive signal.

10. The optical frequency domain reflectometer module according to claim 1, wherein the optical frequency domain reflectometer module is an optical frequency domain reflectometer front-end connectable with a test and/or measurement instrument.

11. An optical frequency domain reflectometer system comprising a test and/or measurement instrument that is connected with the optical frequency domain reflectometer module according to claim 1.

12. The optical frequency domain reflectometer system according to claim 11, wherein the test and/or measurement instrument comprises a signal acquisition and/or analysis circuit connected with an output interface of the optical frequency domain reflectometer module.

13. The optical frequency domain reflectometer system according to claim 11, wherein the optical frequency domain reflectometer module comprises a drive signal input configured to receive a drive signal, and wherein the test and/or measurement instrument is configured to provide the drive signal to the drive signal input of the optical frequency domain reflectometer module.

14. The optical frequency domain reflectometer system according to claim 11, wherein the optical frequency domain reflectometer module comprises an optical output interface, wherein the system further comprises an optical probe interconnected between the optical output interface and the test and/or measurement instrument, and wherein the optical probe is configured to convert the optical signal received via the optical output interface into an electrical signal to be processed by the test and/or measurement instrument.

15. The optical frequency domain reflectometer system according to claim 11, further comprising an optoelectronic device under test connected with the optical interface of the optical frequency domain reflectometer module.

16. A method of operating an optical frequency domain reflectometer system, wherein the method comprises the steps of:
generating an initial light signal,
splitting the initial light signal into a pre-split light signal and a light signal,
processing the pre-split light signal, thereby generating a reference signal,
generating an optical beat signal based on the light signal,
determining resample time-instants based on the reference signal,
resampling the optical beat signal based on the resample time-instants determined, thereby obtaining a resampled optical beat signal, and
computing a magnitude spectrum based on the resampled optical beat signal.

17. The method according to claim 16, wherein a reflection profile of the optoelectronic device under test is retrieved from the magnitude spectrum computed.

18. The method according to claim 16, wherein the resample time-instants are determined by performing a Hilbert-transformation of the reference signal.

19. The method according to claim 16, wherein a Mach-Zehnder-Interferometer processes the pre-split light signal in order to generate the reference signal.

20. The method according to claim 16, wherein the light signal is split into a first split signal and a second split signal, wherein the first split signal is forwarded to an optoelectronic device under test that returns an optical return signal, and wherein the optical beat signal is generated based on the second split signal and the optical return signal obtained from the optoelectronic device under test.
